(19) United States
(12) Patent Application Publication
(10) Pub. No.: US 2001/0033964 A1
(43) Pub. Date: Oct. 25, 2001

(54) Alkylspiroborate salts for use in electrochemical cells

(75) Inventors: Udo Heider, Riedstadt (DE); Michael Schmidt, Seehum-Jugenheim (DE); Andreas Kuehner, Darmstadt (DE); Andrea Schmenger, Riedstadt (DE)

Correspondence Address: MILLEN WHITE ZELANO & BRANIGAN, P.C., Suite 1400, 2200 Clarendon Boulevard, Arlington, VA, 22201, US

(73) Assignee: Merck Patent Gesellschaft mit Beschrankter Haftung

(21) Appl. No.: 09/758,546

(22) Filed: Jan. 12, 2001

Related U.S. Application Data
(63) Continuation-in-part of application No. 09/732,899, filed on Dec. 11, 2000.

(30) Foreign Application Priority Data
Dec. 10, 1999 (DE) 199 59 722.7

(51) Int. Cl. H01M 6/04; H01G 9/035; C01B 35/00; C07F 5/02

(52) U.S. Cl. 429/188; 252/62.2; 423/284; 568/1; 568/6

(57) ABSTRACT

The invention relates to a process for the preparation of borate salts, and to their use in electrochemical cells.

This application is a continuation-in-part application of application Ser. No. 09/732,899 filed Dec. 11, 2000, which is hereby incorporated herein by reference in its entirety.

The invention relates to a process for the preparation of spiroborate salts, and to their use in electrochemical cells.

Lithium ion batteries are amongst the most promising systems for mobile applications. The areas of application extend from high-quality electronic equipment (for example mobile telephones, camcorders) to batteries for electrically driven motor vehicles.

Rechargeable lithium batteries have been commercially available since the early 1990s.

These batteries consist of a negative electrode, a positive electrode, a separator and a non-aqueous electrolyte. The negative electrode is typically Li(MnMe_{z})₂O₄, Li(CoMe_{z})O₂, Li(CoNiₓMe_{z})O₂ or other lithium intercalation and insertion compounds. Positive electrodes can consist of lithium metal, carbon, graphite, graphitic carbon or other lithium intercalation and insertion compounds or alloy compounds. The electrolyte can be a solution containing lithium salts, such as LiPF₆, LiBF₄, LiClO₄, LiAsF₆, LiCF₃SO₃, LiN(CF₃SO₂)₂ or LiC(CF₃SO₂)₃ and mixtures thereof, in aprotic solvents.

In LiPF₆, a highly hydrolysis-sensitive and thermally unstable substance is currently used as conductive salt in many lithium ion batteries. In contact with atmospheric moisture and/or residual water from the solvent, hydrofluoric acid HF immediately forms. In addition to the toxic properties, HF has an adverse effect on the cycle behavior and thus on the performance of the lithium battery, since metals from the electrodes may be dissolved out.

U.S. Pat. No. 4,505,997 describes lithium imides and U.S. Pat. No. 5,273,840 describes lithium methanides. Both salts have high positive-electrode stability and form solutions of high conductivity in organic carbonates. Aluminium, the negative-electrode charge eliminator in lithium ion batteries, is passivated to an inadequate extent, at least by lithium imide. Lithium methanide, by contrast, can only be produced and purified at very great expense. In addition, the electrochemical properties, such as oxidation stability and passivation of aluminium, are highly dependent on the purity of the methanide.

In lithium bis[5-fluoro-2-olatobenzenesulfonato(2-)O,O′]borate(1-), a conductive salt is described which, owing to its properties, is regarded as a highly promising conductive salt for use in lithium ion batteries. However, the high-cost and complex synthesis of the precursors is problematic.

Anionic chelate complexes of the borate anion are described in EP 698,301. On use of organic aromatic diols or aromatic hydroxy acids as ligands, very high thermal stability and good delocalization of negative charge is observed. The lack of oxidation stability or inadequate conductivity in aprotic solvents, which are employed as standard in electrochemical cells, prove to be disadvantageous. The known spiroborates have optimized conductivity at the same time as inadequate oxidation stability or optimized oxidation stability at the same time as inadequate conductivity.

The present invention therefore provides materials which have improved conductivity and are electrochemically stable.

The invention thus provides borate salts of the general formula

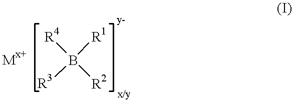

in which:

M is a metal ion, tetraalkylammonium ion,

PR^{a}R^{b}R^{c}R^{d}, P(NR^{a}R^{b})ₖR^{c}ₘR^{d}₄₋ₖ₋ₘ (where k=1-4, m=0-3 and k+m≦4),

C(NR^{a}R^{b}) (NR^{c}R^{d}) (NR^{e}R^{f}), C(R^{z})₃, tropylium or

heterocyclic rings containing P, N, S or O, or fused heterocyclic systems containing these rings,

where R^{a} to R^{f} are H, alkyl or aryl (C₁-C₈), which may be partially substituted by F, Cl or Br,

R^{z} is an aromatic or substituted aromatic ring,

x and y are 1, 2, 3, 4, 5 or 6,

R¹ to R⁴ may be identical or different alkoxy (e.g., forming B—O-alkyl) or carboxyl (e.g., forming B—O—C(O)-alkyl) radicals (C₁-C₈,) which are optionally bonded directly to one another via a single or double bond, e.g., to form a 5-7 membered boron-containing ring.

If M^{x+} is a tetraalkylammonium ion conforming to the general formula [NR′R″R′″R″″], the radicals R′ to R″″ may be identical or different, optionally bonded directly to one another via a single or double bond and have the meaning C_{n′}F_{(2n′+1-x′)}H_{x′}, where n′=1-6 and x′=0-13.

Particularly suitable are borate salts conforming to the formula (I) which are characterized in that M, x, y and R¹ to R⁴ are as defined, and

R¹ to R⁴ are optionally partially or fully substituted by electron-withdrawing groups selected from the group consisting of

F, Cl, N(C_{n′}F_{(2n′+1-x′)}H_{x′})₂, O(C_{n′}F_{(2n′+1-x′)}H_{x′}), SO₂(C_{n′}F_{(2n′+1-x′)}H_{x′})

where

n′ is 1, 2, 3, 4, 5 or 6, and

x′ is 0 to 13.

Where M is a metal ion, it preferably has a valence of 1-3, particularly preferably Li.

Where R^{a} to R^{f} are partially substituted alkyl they are preferably, independently, alkyl of the formula C_{r.}^{I}H₂ₙ^{I}₊₁Xₘ^{I}, in which 1≦n^{I}≦8 and 0≦m^{I}≦2ₙ^{I}+1; preferably m^{I} is 0.

R^{z} is preferably a C₆₋₁₀-aromatic ring, in which one or more H atoms are optionally replaced by F, Cl or Br.

Surprisingly, it has been found that the salts according to the invention have very high electrochemical stability. The compounds of the formula (I), besides the thermal stability which is typical of borates, at the same time have high oxidation stability.

It has been found that the salts according to the invention have high ionic conductivity in aprotic solvents. Suitable solvents are the customary battery solvents, preferably selected from the group consisting of dimethyl carbonate, diethyl carbonate, propylene carbonate, ethylene carbonate, ethyl methyl carbonate, methyl propyl carbonate, γ-butyrolactone, methyl acetate, ethyl acetate, methyl propionate, ethyl propionate, methyl butyrate, ethyl butyrate, dimethyl sulfoxide, dioxolane, sulfolane, acetonitrile, acrylonitrile, tetrahydrofuran, 2-methytetrahydrofuran and mixtures thereof.

The borate salts of the formula (I) and mixtures thereof can be used in electrolytes for electrochemical cells. They can be employed as conductive salts or additives. They can likewise be used in proportions of between 1 and 99% in combination with other conductive salts which are used in electrochemical cells. Examples of suitable conductive salts are those selected from the group consisting of LiPF₆, LiBF₄, LiClO₄, LiAsF₆, LiCF₃SO₃, LiN(CF₃SO₂)₂ and LiC(CF₃SO₂)₃ and mixtures thereof.

The electrolytes may also contain organic isocyanates (DE 199 44 603) for reducing the water content. The electrolytes may likewise contain organic alkali metal salts (DE 199 10 968) as additive. Suitable alkali metal salts are alkali metal borates of the general formula

Li⁺B⁻(OR^{1II})ₘ^{II}(OR^{2II})_{pII} II

in which

m^{II} and p^{II} are 0, 1, 2, 3 or 4, where m^{II}+p^{II}=4, and R^{1II} and R^{2II} are identical or different,

are optionally bonded directly to one another via a single or double bond, (e.g., to form a 5-6-membered ring optionally containing N),

are each, individually or together, an aromatic or aliphatic carboxylic, dicarboxylic or sulfonic acid radical, or

are each, individually or together, an aromatic ring from the group consisting of phenyl, naphthyl, anthracenyl and phenanthrenyl, which may be unsubstituted or mono- to tetrasubstituted by A or Hal, or

are each, individually or together, a heterocyclic aromatic ring from the group consisting of pyridyl, pyrazyl and bipyridyl, which may be unsubstituted or mono- to trisubstituted by A or Hal, or

are each, individually or together, an aromatic hydroxy acid from the group consisting of aromatic hydroxycarboxylic acids and aromatic hydroxysulfonic acids, which may be unsubstituted or mono- to tetrasubstituted by A or Hal,

and

Hal is F, Cl or Br

and

A is alkyl having 1 to 6 carbon atoms, which may be mono- to trihalogenated.

Likewise suitable are alkali metal alkoxides (DE 9910968) of the general formula

Li⁺OR^{III-} III

in which R^{III}

is an aromatic or aliphatic carboxylic, dicarboxylic or sulfonic acid radical, or

is an aromatic ring from the group consisting of phenyl, naphthyl, anthracenyl and phenanthrenyl, which may be unsubstituted or mono- to tetrasubstituted by A or Hal, or

is a heterocyclic aromatic ring from the group consisting of pyridyl, pyrazyl and bipyridyl, which may be unsubstituted or mono- to trisubstituted by A or Hal, or

is an aromatic hydroxy acid from the group consisting of aromatic hydroxycarboxylic acids and aromatic hydroxysulfonic acids, which may be unsubstituted or mono- to tetrasubstituted by A or Hal,

and

Hal is F, Cl or Br

and

A is alkyl having 1 to 6 carbon atoms, which may be mono- to trihalogenated.

In addition, compounds of the general formula

[([R^{1IV}(CR^{2IV}R^{3IV})_{kIV}]_{1IV}A_{xIV})_{yIV}Kt]^{+ -}N(CF₃)₂ IV

where

Kt is N, P, As, Sb, S or Se,

A is N, P, P(O), O, S, S(O), SO₂, As, As(O), Sb or Sb(O),

R^{1IV}, R^{2IV} and R^{3IV}

are identical or different

and are H, halogen, substituted and/or unsubstituted alkyl Cₙ^{IV}H₂^{IV}ₙ₊₁, substituted and/or unsubstituted alkenyl having 1-18 carbon atoms and one or more double bonds, substituted and/or unsubstituted alkynyl having 1-18 carbon atoms and one or more triple bonds, substituted and/or unsubstituted cycloalkyl Cₘ^{IV}H₂^{IV}ₘ₋₁, mono- or polysubstituted and/or unsubstituted phenyl, substituted and/or unsubstituted heteroaryl,

A can be included in R^{1IV}, R^{2IV} and/or R^{3IV} in various positions,

Kt can be included in a cyclic or heterocyclic ring,

the groups bonded to Kt may be identical or different,

where

n^{IV} is 1-18

m^{IV} is 3-7

k^{IV} is 0 or 1-6

l is 1 or 2 in the case where x^{IV}=1 and 1, in the case where x^{IV}=0

x^{IV} is 0 or 1

y^{IV} is 1-4,

may be present (DE 9941566).

These compounds are prepared by reacting an alkali metal salt of the general formula

D^{+ -}N(CF₃)₂

where D⁺ is selected from the group consisting of alkali metals, is reacted, in a polar organic solvent, with a salt of the general formula

[([R^{1IV})CR^{2IV}R^{3IV})ₖ]₁Aₓ)_{y}Kt]^{+ -E}^{IV}

where

Kt, A, R^{1IV}, R^{2IV}, R^{3IV}, k^{IV}, l^{IV}, x^{IV} and y^{IV} are as defined above, and

⁻E^{IV} is F⁻, Cl⁻, Br⁻, I⁻, BF₄⁻, ClO₄⁻, AsF₆⁻, SbF₆⁻ or PF₆⁻.

The compounds according to the invention may also be present in electrolytes comprising compounds of the formula

X−(CYZ)ₘ^{V}−SO₂N(CR^{1V}R^{2V}R^{3V})₂ V

where

X is H, F, Cl, Cₙ^{V}F₂ₙ^{V}₊₁, Cₙ^{V}F₂ₙ^{V}₋₁ or (SO₂)ₖ^{V}N(CR^{1V}R^{2V}R^{3V})₂,

Y is H, F or Cl

Z is H, F or Cl

R^{1V}, R^{2V} and R^{3V} are H and/or alkyl, fluoroalkyl or cycloalkyl

m^{V} is 0-9 and, if X=H, m≠0

n^{V} is 1-9

K^{V} is 0 if m^{V}=0 and k=1 if m^{V}=1-9,

prepared by reacting partially or perfluorinated alkylsulfonyl fluorides with dimethylamine in organic solvents (DE 199 466 73).

Lithium complex salts of the formula

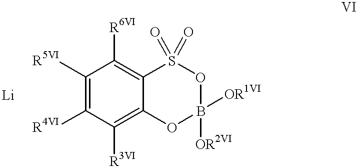

where

R^{1VI} and R^{2VI} are identical or different, are optionally bonded directly to one another via a single or double bond, e.g., to form a 5-6-membered ring, optionally containing N, and are each, individually or together, an aromatic ring from the group consisting of phenyl, naphthyl, anthracenyl and phenanthrenyl, which may be unsubstituted or mono- to hexasubstituted by alkyl (C₁ to C₆), alkoxy groups (C₁ to C₆) or halogen (F, Cl or Br),

or are each, individually or together, an aromatic heterocyclic ring from the group consisting of pyridyl, pyrazyl and pyrimidyl, which may be unsubstituted or mono- to tetrasubstituted by alkyl (C₁ to C₆), alkoxy groups (C₁ to C₆) or halogen (F, Cl or Br),

or are each, individually or together, an aromatic ring from the group consisting of hydroxybenzocarboxyl, hydroxynaphthalenecarboxyl, hydroxybenzosulfonyl and hydroxynaphthalenesulfonyl, which may be unsubstituted or mono- to tetrasubstituted by alkyl (C₁ to C₆), alkoxy groups (C₁ to C₆) or halogen (F, Cl or Br),

R^{3VI}-R^{6VI} may each, individually or in pairs and optionally bonded directly to one another via a single or double bond, (e.g., to form a 5-6-membered ring optionally containing N), have the following meanings:

1. alkyl (C₁ to C₆), alkoxy (C₁ to C₆) or halogen (F, Cl or Br)

2. an aromatic ring from the groups consisting of phenyl, naphthyl, anthracenyl and phenanthrenyl, which may be unsubstituted or mono- to hexasubstituted by alkyl (C₁ to C₆), alkoxy groups (C₁ to C₆) or halogen (F, Cl or Br),

pyridyl, pyrazyl and pyrimidyl, which may be unsubstituted or mono- to tetrasubstituted by alkyl (C₁ to C₆), alkoxy groups (C₁ to C₆) or halogen (F, Cl or Br),

which are prepared by the following process (DE 199 32 317):

a) chlorosulfonic acid is added to 3-, 4-, 5- or 6-substituted phenol in a suitable solvent,

b) the intermediate from a) is reacted with chlorotrimethylsilane, and the product is filtered and subjected to fractional distillation,

c) the intermediate from b) is reacted with lithium tetramethoxyborate(1-) in a suitable solvent, and the end product is isolated therefrom,

may also be present in the electrolyte.

It is also possible to use electrolytes comprising complex salts of the general formula (DE 199 51 804)

M^{x+VII}[E^{VII}Z]^{y-}ₓ^{VII}_{/y}^{VII} VII

in which:

X^{VII} and y^{VII} are 1, 2, 3, 4, 5 or 6

M^{x+VII} is a metal ion

E^{VII} is a Lewis acid selected from the group consisting of

BR^{1VII}R^{2VII}R^{3VII}, AlR^{1VII}R^{2VII}R^{3VII}, PR^{1VII}R^{2VII}R^{3VII}R^{4VII}R^{5VII}, AsR^{1VII}R^{2VII}R^{3VII}R^{4VII}R^{5VII} and VR^{1VII}R^{2VII}R^{3VII}R^{4VII}R^{5VII},

R^{1VII} to R^{5VII} are identical or different, are optionally bonded directly to one another via a single or double bond, (e.g., to form a 5-6-membered ring optionally containing N), and are each, individually or together,

a halogen (F, Cl or Br),

an alkyl or alkoxy radical (C₁ to C₈), which may be partially or fully substituted by F, Cl or Br,

an aromatic ring, optionally bonded via oxygen, from the group consisting of phenyl, naphthyl, anthracenyl and phenanthrenyl, which may be unsubstituted or mono- to hexasubstituted by alkyl (C₁ to C₈) or F, Cl or Br,

an aromatic heterocyclic ring, optionally bonded via oxygen, from the group consisting of pyridyl, pyrazyl and pyrimidyl, which may be unsubstituted or mono- to tetrasubstituted by alkyl (C₁ to C₈) or F, Cl or Br, and

Z is OR^{6VII}, NR^{6VII}R^{7VII}, CR^{6VII}R^{7VII}R^{8VII}, OSO₂R^{6VII}, N(SO₂R^{6VII}) (SO₂R^{7VII}), C(SO₂R^{6VII}) (SO₂R^{7VII}) (SO₂R^{8VII}) or OCOR^{6VII},

where

R^{6VII} to R^{8VII} are identical or different, are optionally bonded directly to one another via a single or double bond (e.g., to form a 5-6-membered ring optionally containing N), and are each, individually or together,

hydrogen or as defined for R^{1VII} to R^{5VII},

prepared by reacting a corresponding boron or phosphorus Lewis acid/solvent adduct with a lithium or tetraalkylammonium imide, methanide or triflate.

It is also possible for additives such as silane compounds of the general formula

SiR^{1VIII}R^{2VIII}R^{3VIII}R^{4VIII} VIII

where R^{1VIII} to R^{4VIII} are H

C_{y}^{VIII}F_{2y}^{VIII}_{+1-z}^{VIII}H_{z}^{VIII}

OC_{y}^{VIII}F_{2y}^{VIII}_{+1-z}^{VIII}H_{z}^{VIII}

OC(O)C_{y}^{VIII}F_{2y}^{VIII}_{+1-z}^{VIII}H_{z}^{VIII}

OSO₂C_{y}^{VIII}F_{2y}^{VIII}_{+1-z}^{VIII}H_{z}^{VIII}

and

1≦x^{VIII}<6

1≦y^{VIII}≦8, and

0≦z^{VIII}≦2y^{VIII}+1

and

R^{1VIII}-R^{4VIII} are identical or different

and are an aromatic ring from the group consisting of phenyl and naphthyl, which may be unsubstituted or monosubstituted or polysubstituted by F, C_{y}^{VIII}F₂^{VIII}_{y}^{VIII}_{+1-z}^{VIII}H_{z}^{VIII}, OC_{y}^{VIII} F_{2y}^{VIII}_{+1-z}^{VIII}H_{z}^{VIII}, OC(O)C_{y}^{VIII}F_{2y}^{VIII}_{+1-z}^{VIII}H_{z}^{VIII}, OSO₂C_{y}^{VIII}F_{2y}^{VIII}_{+1-z}^{VIII}H_{z}^{VIII}, N(Cₙ^{VIII}F₂ₙ^{VIII}_{+1-z}^{VIII}H_{z}^{VIII})₂, or

is a heterocyclic aromatic ring from the group consisting of pyridyl, pyrazyl and pyrimidyl, each of which may be monosubstituted or polysubstituted by F, C_{y}^{VIII}F_{2y}^{VIII}_{+1-z}^{VIII}H_{z}^{VIII}, OC_{y}^{VIII}F_{2y}^{VIII}_{+1-z}^{VIII}H_{z}^{VIII}, OC(O)C_{y}^{VIII}F_{2y}^{VIII}_{+1-z}^{VIII}H_{z}^{VIII}, OSO₂C_{y}^{VIII}F_{2y}^{VIII}_{+1-z}^{VIII}H_{z}^{VIII}, N(Cₙ^{VIII}F₂ₙ^{VIII}_{+1-z}^{VIII}H_{z}^{VIII})₂ (DE 100 276 26) to be present.

The compounds according to the invention may also be employed in electrolytes comprising lithium fluoroalkylphosphates of the following formula

Li⁺[PFₓ^{I}(C_{y}^{IX}F_{2y}^{IX}_{+1-z}^{IX}H_{z}^{IX})₆₋ₓ^{IX}]⁻ IX

in which

1≦x^{IX}≦5

3≦y^{IX}≦8

0≦z^{IX}≦2y^{IX}+1

and the ligands (C_{y}^{IX}F_{2y}^{IX}_{+1-z}^{IX}H_{z}^{IX}) may be identical or different, where the compounds of the general formula

Li⁺[PFₐ^{X}(CH_{b}^{X}F_{c}^{X}(CF₃)_{d}^{X})ₑ^{X}]⁻ X

in which a^{X} is an integer from 2 to 5, b^{X}=0 or 1, c^{X}=0 or 1, d^{X}=2 and

e^{X} is an integer from 1 to 4, with the provisos that b^{X} and c^{X} are not simultaneously each=0, and that the sum of a^{X}+e^{X} is equal to 6, and the ligands (CH_{b}^{X}F_{c}^{X}(CF₃)_{d}^{X}) may be identical or different, are excluded (DE 100 089 55). The process for the preparation of these lithium fluoroalkylphosphates is characterized in that at least one compound of the general formula

Hₘ^{X}P(Cₙ^{X}H₂ₙ^{X}₊₁)₃₋ₘ^{X} (Xa),

OP(Cₙ^{X}H₂ₙ^{X}₊₁)₃ (Xb),

Clₘ^{X}P(Cₙ^{X}H₂ₙ^{X}₊₁)₃₋ₘ^{X} (Xc),

Fₘ^{X}P(Cₙ^{X}H₂ₙ^{X}₊₁)₃₋ₘ^{X} (Xd),

Clₒ^{X}P(Cₙ^{X}H₂ₙ^{X}₊₁)₅₋ₒ^{X} (Xe),

Fₒ^{X}P(Cₙ^{X}H₂ₙ^{X}₊₁)₅₋ₒ^{X} (Xf),

in which in each case

0<m^{X}<2, 3<n^{X}<8 and 0<o^{X}<4,

is fluorinated by electrolysis in hydrogen fluoride, the resultant mixture of fluorination products is separated by extraction, phase separation and/or distillation, and the resultant fluorinated alkylphosphorane is reacted with lithium fluoride in an aprotic solvent or solvent mixture with exclusion of moisture, and the resultant salt is purified and isolated by conventional methods.

The compounds according to the invention may also be employed in electrolytes which comprise salts of the formula

Li[P(OR^{1XI})ₐ^{XI}(OR^{2XI})_{b}^{XI}(OR^{3XI})_{c}^{XI}(OR^{4XI})_{d}^{XI}Fₑ^{XI}] XI

in which 0<a^{XI}+b^{XI}+c^{XI}+d^{XI}≦5 and a^{XI}+b^{XI}+c^{XI}+d^{XI}+e^{XI}=6, and R^{1XI} to R^{4XI}, independently of one another, are alkyl, aryl or heteroaryl radicals, where at least two of R^{1XI} to R^{4XI} may be bonded directly to one another by a single or double bond (e.g., to form a 5-6-membered ring optionally containing N), (DE 100 16 801). The compounds are prepared by reacting phosphorus(V) compounds of the general formula

P(OR^{1XI})ₐ^{XI}(OR^{2XI})_{b}^{XI}(OR^{3XI})_{c}^{XI}(OR^{4XI})_{d}^{XI}Fₑ^{XI} XIa

in which 0<a^{XI}+b^{XI}+c^{XI}+d^{XI}≦5 and a^{XI}+b^{XI}+c^{XI}+d^{XI}+e^{XI}=5, and R^{1XI} to R^{4XI} are as defined above, with lithium fluoride in the presence of an organic solvent.

The electrolyte may also comprise ionic liquids of the general formula

K⁺A⁻ XII

in which:

K⁺ is a cation selected from the group consisting of

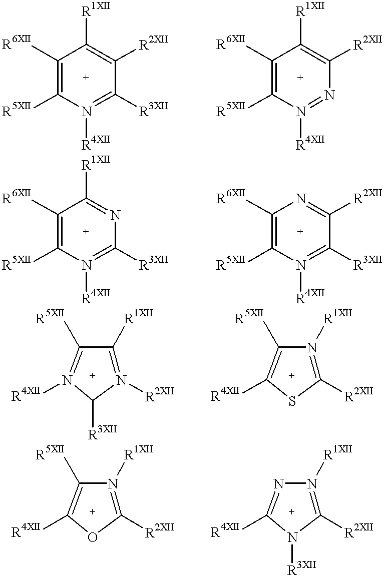

where R^{1XII} to R^{5XII} are identical or different, are optionally bonded directly to one another by a single or double bond, (e.g., to form a 5-6-membered ring optionally containing N), and each, individually or together, have the following meaning:

H

halogen,

alkyl radical (C₁ to C₈), which may be partially or fully substituted by further groups, preferably F, Cl, N(Cₙ^{XII}F₍₂ₙ^{XII}₊₁₋ₓ^{XII}₎Hₓ^{XII})₂, O(Cₙ^{XII}F₍₂ₙ^{XII}₊₁₋ₓ^{XII}₎Hₓ^{XII}), SO₂(Cₙ^{XII}F₍₂ₙ^{XII}₊₁₋ₓ^{XII}₎Hₓ^{XII}), Cₙ^{XII}F₍₂ₙ^{XII}₊₁₋ₓ^{XII}₎Hₓ^{XII} where 1<n^{XII}<6 and 0<x^{XII}≦13

and

A⁻ is an anion selected from the group consisting of

[B(OR^{1XII})ₙ^{XII}(OR^{2XII})ₘ^{XII}(OR^{3XII})ₒ^{XII}(OR^{4XII})ₚ^{XII}]⁻

where 0≦n^{XII}, m^{XII}, o^{XII}, p^{XII}≦4 and

m^{XII}+n^{XII}+o^{XII}+p^{XII}=4

where R^{1XII} to R^{4XII} are different or identical in pairs, are optionally bonded directly to one another by a single or double bond, (e.g., to form a 5-6-membered ring optionally containing N), and are each, individually or together,

an aromatic ring from the group consisting of phenyl, naphthyl, anthracenyl and phenanthrenyl, which may be unsubstituted or monosubstituted or polysubstituted by Cₙ^{XII}F₍₂ₙ^{XII}₊₁₋ₓ^{XII}₎Hₓ^{XII}, where 1<n^{XII}<6 and 0<x^{XII}≦13, or halogen (F, Cl or Br),

an aromatic heterocyclic ring from the group consisting of pyridyl, pyrazyl and pyrimidyl, which may be unsubstituted or monosubstituted or polysubstituted by Cₙ^{XII}F₍₂ₙ^{XII}₊₁₋ₓ^{XII}₎Hₓ^{XII}, where 1<n^{XII}<6 and 0<x^{XII}≦13, or halogen (F, Cl or Br),

an alkyl radical (C₁ to C₈), which may be partially or fully substituted by further groups, preferably F, Cl, N(Cₙ^{XII}F₍₂ₙ^{XII}₊₁₋ₓ^{XII}₎Hₓ^{XII})₂, O(Cₙ^{XII}F₍₂ₙ^{XII}₊₁₋ₓ^{XII}₎Hₓ^{XII}), SO₂(Cₙ^{XII}F₍₂ₙ^{XII}₊₁₋ₓ^{XII}₎Hₓ^{XII}), Cₙ^{XII}F₍₂ₙ^{XII}₊₁x^{XII}₎Hₓ^{XII} where 1<n^{XII}<6 and 0<x^{XII}≦13,

or OR^{1XII} to OR^{4XII}

individually or together, are an aromatic or aliphatic carboxyl, dicarboxyl, oxysulfonyl or oxycarboxyl radical, which may be partially or fully substituted by further groups, preferably F, Cl, N(Cₙ^{XII}F₍₂ₙ^{XII}₊₁₋ₓ^{XII}₎Hₓ^{XII})₂, O(Cₙ^{XII}F₍₂ₙ^{XII}₊₁₋ₓ^{XII}₎Hₓ^{XII}), SO₂(Cₙ^{XII}F₍₂ₙ^{XII}₊₁₋ₓ^{XII}₎Hₓ^{XII}), Cₙ^{XII}F₍₂ₙ^{XII}₊₁₋ₓ^{XII}₎Hₓ^{XII} where 1<n^{XII}<6 and 0<x^{XII}≦13 (DE 100 265 65). Ionic liquids K⁺A⁻, where K⁺ is defined as above and

A⁻ is an anion selected from the group consisting of

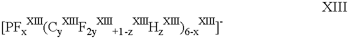

and

1≦x^{XIII}<6

1≦y^{XIII}≦8 and

0≦z^{XIII}≦2y^{XIII}+1

may also be present (DE 100 279 95).

The compounds according to the invention may be employed in electrolytes for electrochemical cells which comprise positive-electrode material consisting of coated metal cores, selected from the group consisting of Sb, Bi, Cd, In, Pb, Ga and tin or alloys thereof (DE 100 16 024). The process for the preparation of this positive-electrode material is characterized in that

a) a suspension or sol of the metal or alloy core in urotropin is prepared,

b) the suspension is emulsified with C₅-C₁₂-hyrocarbons,

c) the emulsion is precipitated onto the metal or alloy cores, and

d) the metal hydroxides or oxyhydroxides are converted into the corresponding oxide by heating the system.

The compounds according to the invention can also be employed in electrolytes for electrochemical cells with negative electrodes comprising customary lithium intercalation and insertion compounds, but also with negative-electrode materials consisting of lithium mixed oxide particles which are coated with one or more metal oxides (DE 199 22 522) by suspending the particles in an organic solvent, adding a solution of a hydrolyzable metal compound and a hydrolysis solution to the suspension, and then filtering off, drying and optionally calcining the coated particles. They can also consist of lithium mixed oxide particles which are coated with one or more polymers (DE 199 46 066), obtained by a process in which the particles are suspended in a solvent, and the coated particles are subsequently filtered off, dried and optionally calcined. The compounds according to the invention can likewise be employed in systems with negative electrodes which consist of lithium mixed oxide particles which are coated with one or more layers of alkali metal compounds and metal oxides (DE 100 14 884). A process for the preparation of these materials is characterized in that the particles are suspended in an organic solvent, an alkali metal salt compound suspended in an organic solvent is added, metal oxides dissolved in an organic solvent are added, a hydrolysis solution is added to the suspension, and the coated particles are subsequently filtered off, dried and calcined. The compounds according to the invention can likewise be employed in systems which comprise positive electrode materials containing doped tin oxide (DE 100 257 61). This positive electrode material is prepared by

a) adding urea to tin chloride solution,

b) adding urotropin and a suitable dopant compound to the solution,

c) emulsifying the resultant sol in petroleum ether,

d) washing the resultant gel and removing the solvent by suction, and

e) drying and heating the gel.

The compounds according to the invention can likewise be employed in systems comprising positive electrode materials containing reduced tin oxide (DE 100 257 62). This positive electrode material is prepared by

a) adding urea to a tin chloride solution,

b) adding urotropin to the solution,

c) emulsifying the resultant sol in petroleum ether,

d) washing the resultant gel and removing the solvent by suction,

e) drying and heating the gel, and

f) exposing the resultant SnO₂ to a reducing gas stream in an aeratable oven.

The borate salts according to the invention are thus particularly suitable as conductive salts or additives for electrochemical cells. They are suitable for use in batteries, in particular lithium ion batteries, and supercapacitors.

A general example of the invention is explained in greater detail below.

For the preparation of the borate salts according to the invention, a lithium tetraalcoholatoborate or a 1:1 mixture of lithium alkoxide with a corresponding borate is introduced in an aprotic solvent. This solution is, if necessary, warmed somewhat so that the borate dissolves.

Lithium tetraalcoholatoborates which are suitable for the reaction are the derivatives of methanol, ethanol, propanol, but also of other short-chain alcohols. However, particular preference is given to the use of the derivatives of methanol or ethanol since these alcohols, owing to their low boiling point, can be removed from the reaction mixture at relatively low temperatures after the complex formation has taken place. Li tetraalcoholatoborates can be prepared, e.g., according to Example 5b of WO 98/07729.

For the complex formation, a suitable hydroxyl or carboxyl compound (e.g., 1,2-diole, 1,3-diole, hydroxycarboxylic acid, tetraalcoholatoborate, metal alkoxide, metal carbonate or dicarboxylic acid) is added at room temperature in a ratio of 2:1 or 4:1, if necessary under a protective-gas atmosphere. In order to complete the reaction, the reaction solution is, if necessary, subsequently stirred for some time at a temperature between 60 and 150° C., preferably between 60 and 120° C. The subsequent stirring may be superfluous in the case of complex-formation reactions which proceed very quickly.

It is possible to use aprotic solvents, preferably selected from the group consisting of acetonitrile, acetone, nitromethane, dimethylformamide, toluene, dimethyl carbonate, diethyl carbonate, dimethylacetamide and dimethyl sulfoxide. Particular preference is given to toluene.

The alcohol formed during the reaction is, if it interferes with the subsequent isolation of the complex salt prepared, separated off with application of a slight vacuum and possibly by slight warming to about 50 to 60° C. Depending on the solubility of the lithium complex salt prepared in the aprotic solvent used, the reaction mixture is evaporated or the solvent is distilled off completely, and, if crystallization does not take place spontaneously, cooled for several hours at a temperature of from 0 to 10° C. The crystalline product is separated off in a conventional manner and dried by slow warming.

Particularly suitable for the complex formation are alkoxides and dialkoxides which are hydroxylated in adjacent positions, such as perfluoropinacolate, perfluoroglycolate and 1,2-dihydroxyperfluoropropylate. Without further elaboration, it is believed that one skilled in the art can, using the preceding description, utilize the present invention to its fullest extent. The following preferred specific embodiments are, therefore, to be construed as merely illustrative, and not limitative of the remainder of the disclosure in any way whatsoever.

In the foregoing and in the following examples, all temperatures are set forth uncorrected in degrees Celsius; and, unless otherwise indicated, all parts and percentages are by weight.

The entire disclosure of all applications, patents and publications, cited above, and of corresponding German application No. 199 59 722.7, filed Dec. 10, 1999, is hereby incorporated by reference.

### EXAMPLES

### Example 1

### Preparation of lithium bis[perfluoropinacolyl-O,O′(2-)]borate(1-)

2 mol of perfluoropinacole are dissolved in toluene.

This solution is added to a suspension of 1 mol of lithium methanolatoborate in toluene. The reaction mixture is heated to 100° C., and the methanol formed is distilled off.

On cooling, colorless, needle-shaped crystals precipitate.

The salt is purified by recrystallization and dried to constant weight under reduced pressure.

### Example 2

### Electrochemical Stability of the Electrolytes in EC/DMC

In each case, a number of cyclic voltammograms were recorded successively in a measurement cell containing platinum electrode, lithium counterelectrode and lithium reference electrode. To this end, the potential was firstly increased from the rest potential to 6 V against Li/Li⁺ at a rate of 20 mV/s, and then reduced back to the rest potential.

The characteristic curve shown in FIG. 1 is obtained. The electrolyte is thus suitable for use in lithium ion batteries with transition-metal negative electrode.

### Example 3

Ionic Conductivity of the Conductive Salt in EC/DMC

| | Solvent | Conductivity |
|---|---|---|
| Conductive salt | (1:1) | [mS/cm] |
| Lithium bis[perfluoropinacolyl- | EC/DMC | 5.4 |
| O,O′(2-)]borate(1-) | | |
| LiPF₆ | EC/DMC | 5.0 |
| Li[N(SO₂CF₃)₂] | EC/DEC | 5.8 |

The concentration of the conductive salt in the solvent is 0.3 mol/l. The measurements were carried out at a temperature of 25° C.

The salts according to the invention have conductivities which are interesting for use in electrochemical cells and are comparable with known conductive salts, such as lithium hexafluorophosphate or lithium imide.

### Example 4

### Preparation of tetramethylphosphonium bis[oxalato-O,O′(2-)]borate(1-) via lithium bis[oxalato-O,O′(2-)]-borate(1-)

Lithium bis[oxalato-O,O′(2-)]borate(1-) (prepared in accordance with DE 198 29 030) is reacted with tetramethylphosphonium chloride at room temperature in acetonitrile to give tetramethylphosphonium bis-[oxalato-O,O′(2-)]borate(1-). The resultant lithium chloride is filtered off at 50° C., and the product is recrystallized from acetonitrile/methyl tert-butyl ether.

### Example 5

### Preparation of tetraethylammonium bis[oxalato-O,O′-(2-)]borate(1-)

Oxalic acid, tetraethylammonium hydroxide and boric acid are suspended in toluene in the molar ratio 2:1:1. After the stoichiometric amount of water formed in the reaction has been removed by azeotropic distillation, the crude product is recrystallized a number of times from acetonitrile/DMC.

Instead of in toluene, the reaction can also be carried out analogously in any other aprotic solvent which forms an azeotrope with water. In this case, diethyl carbonate, in which the crude product can also be recrystallized directly, has proven particularly successful.

¹H-NMR (200 MHz, DMSO, TMS) 1.2 ppm (t) 3.20 ppm (q)

### Example 6

### Preparation of lithium bis[malonato-O,O′(2-)]borate(1-)

Malonic acid, lithium carbonate and boric acid are suspended in toluene in the molar ratio 2:0.5:1. After the stoichiometric amount of water formed in the reaction has been removed by azeotropic distillation, the crude product is recrystallized a number of times from acetonitrile.

Lithium hydroxide can also be employed instead of lithium carbonate. In this case, the malonic acid:lithium hydroxide:boric acid molar ratio changes to 2:1:1.

¹H-NMR (200 MHz, DMSO, TMS) 3.45 ppm (s)

### Example 7

### Preparation of tetramethylphosphonium bis[malonato-O,O′(2-)]borate(1-) via lithium bis[malonato-O,O′(2-)]-borate(1-)

Lithium bis[malonato-O,O′(2-)]borate(1-) is reacted with tetramethylphosphonium chloride at room temperature in acetonitrile to give tetramethylphosphonium bis[malonato-O,O′(2-)]borate(1-) . The lithium chloride formed is filtered off at 50° C., and the product is recrystallized from acetonitrile/methyl tert-butyl ether.

### Example 8

### Preparation of tetraethylammonium bis[malonato-O,O′-(2-)]borate(1-)

Oxalic acid, tetraethylammonium hydroxide and boric acid are suspended in toluene in the molar ratio 2:1:1. After the stoichiometric amount of water formed in the reaction has been removed by azeotropic distillation, the crude product is recrystallized a number of times from acetonitrile/DMC.

Instead of in toluene, the reaction can also be carried out in any other aprotic solvent which forms an azeotrope with water. In this case, diethyl carbonate, from which the crude product can also be recrystallized directly, has proven particularly successful.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

1. A borate salt of formula I 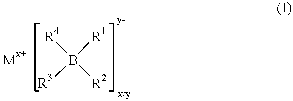
wherein
M is a metal ion, a tetraalkylammonium ion,
PR^{a}R^{b}R^{c}R^{d}, P(NR^{a}R^{b})ₖR^{c}ₘR^{d}₄₋ₖ₋ₘ
C(NR^{a}R^{b}) (NR^{c}R^{d}) (NR^{e}R^{f}), C(R^{z})₃, tropylium or
a heterocyclic ring containing P, N, S or O, or a fused heterocyclic system containing a P, N, S or O-containing ring,
k=1-4, m=0-3 and k+m≦4,
R^{a} to R^{f} are H, C₁₋₈-alkyl or C₁₋₈-aryl(C₁-C₈), which may be partially substituted by F, Cl or Br,
R^{z} is an aromatic or substituted aromatic ring,
x and y is 1, 2, 3, 4, 5 or 6,
R¹ to R⁴ may be identical or different C₁₋₈-alkoxy or C₁₋₈-carboxyl radicals which are optionally bonded directly to one another via a single or double bond, and are optionally partially or fully substituted by electron-withdrawing groups which are
F, Cl, N(C_{n′}F_{(2n′+1-x′)}H_{x′})₂, O(C_{n′}F_{(2n′+1-x′)}Hₓ), or SO₂(C_{n′}F_{(2n′+1)}H_{x′})
wherein
n′ is 1, 2, 3, 4, 5 or 6, and
X′ is 0 to 13.

2. The borate salt according to claim 1, wherein R¹ to R⁴ are partially or fully substituted by electron-withdrawing groups which are
F, Cl, N(C_{n′}F_{(2n′+1-x′)}H_{x′})₂, O(C_{n′}F_{(2n′+1-x′)}Hₓ), or O₂(C_{n′}F_{(2n′+1)}H_{x′})
wherein
n′ is 1, 2, 3, 4, 5 or 6, and
X′ is 0 to 13.

3. The borate salt according to claim 1, where M^{X+} is a tetraalkylammonium ion of the formula NR′R″R′″R″″, wherein R′, R″, R′″ and R″″ are each, independently, C_{n′}F_{(2n′+1-x′)}, in which n′ is 1-6 and x′ is 0-13, and R′, R″, R′″ and R″″ are each, independently, optionally bonded to at least another one MR′, R″, R′″ or R″″ via a simple or double bond.

4. An electrolyte comprising at least one conductive salt, wherein said salt is a compound of claim 1.

5. An electrolyte according to claim 4, comprising at least two conductive salts.

6. An electrochemical cell containing an electrolyte according to claim 4.

7. An electrochemical cell containing an electrolyte according to claim 5.

8. A battery or supercapacitor comprising an electrrochemical cell according to claim 6.

9. A process for the preparation of an electrochemical cell, battery or supercapacitor, comprising placing in contact with an electrode an electrolyte according to claim 4.

10. A process for the preparation of a battery or supercapacitor, comprising placing into a container an electrochemical cell according to claim 6.
